(19) United States
(12) Patent Application Publication
(10) Pub. No.: US 2026/0005601 A1
(43) Pub. Date: Jan. 1, 2026

(54) ELECTRONIC DEVICE COMPRISING 3-LEVEL PFC CIRCUIT, AND CONTROL METHOD THEREOF

(71) Applicants: Samsung Electronics Co., Ltd., Suwon-si (KR); KOOKMIN UNIVERSITY INDUSTRY ACADEMY COOPERATION FOUNDATION, Seoul (KR)

(72) Inventors: Jungwoo YANG, Suwon-si (KR); Moonyoung KIM, Suwon-si (KR); Sang-Kyoo HAN, Suwon-si (KR); Jeongil KANG, Suwon-si (KR); Seung Myung LEE, Suwon-si (KR); June Bong JEONG, Suwon-si (KR); Sungyong JOO, Suwon-si (KR)

(21) Appl. No.: 19/320,732

(22) Filed: Sep. 5, 2025

Related U.S. Application Data
(63) Continuation of application No. PCT/KR2024/002513, filed on Feb. 27, 2024.

(30) Foreign Application Priority Data
Mar. 15, 2023 (KR) 10-2023-0033911

(51) Int. Cl. H02M 1/42; H02M 7/217

(52) U.S. Cl. CPC H02M 1/4233; H02M 7/217

(57) ABSTRACT

An electronic apparatus may include a power factor correction (PFC) circuit and a control circuit for controlling the operation of the PFC circuit, wherein the PFC circuit may include one or more of: an inductor connected to one end of an input voltage unit; a switch unit comprising a first switch connected in series to the inductor, and a second switch connected in series to the first switch; a flying capacitor unit comprising a first diode and a flying capacitor connected in series to each other and connected in parallel to the first switch; and an output unit comprising a second diode and an output capacitor connected in series to each other and connected in parallel to the flying capacitor and the second switch, and the control circuit comprises a first control circuit which obtains an on-off control signal for the first switch on the basis of the output voltage of the output capacitor and transmits the signal to the first switch, and a second control circuit which obtains an on-off control signal for the second switch on the basis of the flying voltage of the flying capacitor and transmits the signal to the second switch.

### CROSS-REFERENCE TO RELATED APPLICATIONS

This application is a continuation application of International Application No. PCT/KR2024/002513, filed on Feb. 27, 2024, in the Korean Intellectual Property Receiving Office, and claiming priority to Korean Patent Application No. 10-2023-0033911 filed Mar. 15, 2023, the disclosures of which are all hereby incorporated by reference herein in their entireties.

### TECHNICAL FIELD

Certain example embodiments may relate to an electronic apparatus and/or a control method thereof, and for example, to an electronic apparatus including a 3-level power factor correction (PFC) circuit, and/or a control method thereof.

### BACKGROUND

Various types of electronic apparatus have been developed and distributed. In particular, an electronic apparatus including a power factor correction circuit, e.g., a PFC circuit, has recently been developed and distributed to meet an increase in total power consumption and various regulations caused by an enlargement of the electronic apparatus.

A conventional PFC circuit may apply a general boost converter topology, which not only increases a voltage stress on a switching semiconductor device in the PFC circuit, but also increases a current ripple of an inductor, thus requiring an inductor having a large magnitude.

To address these issues, a PFC circuit using a 3-level boost converter topology has been proposed. However, such a PFC circuit may reduce the voltage stress on the switching semiconductor device and the current ripple of the inductor only if all devices in the PFC circuit are ideally operated.

Therefore, there has been a demand for a PFC circuit capable of performing a power factor correction operation and an output voltage control even if there is a difference in characteristics between the switching devices or a difference (e.g., offset) between return signals.

### SUMMARY

According to an example embodiment, provided is an electronic apparatus including: a power factor correction (PFC) circuit; and a control circuit configured to control an operation of the PFC circuit, wherein the PFC circuit may include one or more of an inductor connected directly or indirectly to one end of an input voltage unit, a switch unit including a first switch connected direct or indirectly in series with an inductor and a second switch connected directly or indirectly in series with the first switch, a flying capacitor unit connected in parallel with the first switch, and may include a first diode and a flying capacitor connected in series with each other, and an output unit connected in parallel with the flying capacitor and the second switch, and including a second diode and an output capacitor connected in series with each other, and the control circuit may include a first control circuit configured to obtain an on-off control signal for the first switch on the basis of an output voltage of the output capacitor, and transmit the obtained on-off control signal for the first switch to the first switch, and a second control circuit configured to obtain an on-off control signal for the second switch on the basis of a flying voltage of the flying capacitor, and transmit the obtained on-off control signal for the second switch to the second switch.

According to an example embodiment, provided is a control method of an electronic apparatus, which may include one or more of a power factor correction (PFC) circuit, and a control circuit for controlling an operation of the PFC circuit, the PFC circuit including an inductor connected directly or indirectly to one end of an input voltage unit, a switch unit including a first switch connected in series with an inductor and a second switch connected in series with the first switch, a flying capacitor unit connected in parallel with the first switch, and including a first diode and a flying capacitor connected in series with each other, and an output unit connected in parallel with the flying capacitor and the second switch, and including a second diode and an output capacitor connected in series with each other, wherein the method may include: obtaining, by a first control circuit included in the control circuit, an on-off control signal for the first switch on the basis of an output voltage of the output capacitor, and transmitting the obtained on-off control signal for the first switch to the first switch; and obtaining, by a second control circuit included in the control circuit, an on-off control signal for the second switch on the basis of a flying voltage of the flying capacitor, and transmitting the obtained on-off control signal for the second switch to the second switch.

### BRIEF DESCRIPTION OF DRAWINGS

FIG. 1 is a diagram for describing a power factor correction (PFC) circuit and a 3-level PFC circuit according to prior art.

FIG. 2 is a diagram for describing the 3-level PFC circuit operated in a buck mode.

FIG. 3 is a diagram for describing a main waveform of the 3-level PFC circuit operated in the buck mode.

FIG. 4 is a diagram for describing the 3-level PFC circuit operated in a boost mode.

FIG. 5 is a diagram for describing a main waveform of the 3-level PFC circuit operated in the boost mode.

FIG. 6 is a graph for comparing a magnitude of an inductor included in the PFC circuit with a magnitude of an inductor included in the 3-level PFC circuit.

FIG. 7 is a diagram for describing a control circuit for controlling the PFC circuit included in an electronic apparatus according to prior art.

FIG. 8 is a diagram for describing a main waveform of the PFC circuit included in the electronic apparatus according to prior art.

FIG. 9 is a diagram for describing a control circuit for controlling the 3-level PFC circuit included in the electronic apparatus according to prior art.

FIG. 10 is a graph for describing a pulse width modulation (PWM) signal from the control circuit for controlling the 3-level PFC circuit according to prior art.

FIG. 11 is a diagram for describing the control circuit for controlling the 3-level PFC circuit to maintain a magnitude of a flying voltage at half of a magnitude of an output voltage according to prior art.

FIG. 12 is a graph for describing a waveform of an on-off control signal for a first switch and a waveform of an on-off control signal for a second switch according to prior art.

FIG. 13 is a graph for describing a PWM signal from the control circuit for controlling the 3-level PFC circuit according to prior art.

FIG. 14 is a diagram for describing a 3-level PFC circuit and a control circuit according to an example embodiment.

FIG. 15 is a circuit diagram for describing the 3-level PFC circuit according to an example embodiment.

FIG. 16 is a diagram for describing each of a first control circuit and a second control circuit according to an example embodiment.

FIG. 17 is a diagram for describing a charging or discharging current flowing through a flying capacitor based on a triangle wave return signal according to an example embodiment.

FIG. 18 is a diagram for describing the charging or discharging current flowing through the flying capacitor based on the triangle wave return signal according to an example embodiment.

FIG. 19 is a graph for describing the output voltage and flying voltage of the 3-level PFC circuit if there is a difference between the return signals according to an example embodiment.

FIG. 20 is a diagram for describing a change in current flowing through an inductor included in the 3-level PFC circuit if there is a difference between the return signals according to an example embodiment.

FIG. 21 is a graph for describing the output voltage and flying voltage of the 3-level PFC circuit if there is a difference between the return signals according to an example embodiment.

FIG. 22 is a graph for describing the output voltage and flying voltage of the 3-level PFC circuit if there is a difference between gate signals according to an example embodiment.

FIG. 23 is a diagram for describing a change in current flowing through the inductor included the 3-level PFC circuit if there is a difference between the gate signals according to an example embodiment.

FIG. 24 is a graph for describing the output voltage and flying voltage of the 3-level PFC circuit if there is a difference between the gate signals according to an example embodiment.

FIG. 25 is a flowchart for describing a control method of an electronic apparatus according to an example embodiment.

### DETAILED DESCRIPTION

Terms used in the specification are briefly described, and the present disclosure is then described in detail.

General terms that are currently widely used are selected as terms used in embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

The present disclosure may be variously modified and have several embodiments, and specific embodiments of the present disclosure are thus illustrated in the accompanying drawings and described in detail in the detailed description. However, it should be understood that the present disclosure is not limited to specific embodiments, and includes all modifications, equivalents, and substitutions, included in the disclosed spirit and scope of the present disclosure. If it is determined that a detailed description of any known art related to the embodiments may obscure the gist of the present disclosure, the detailed description will be omitted.

Terms “first”, “second”, and the like, may be used to describe various components. However, the components are not to be construed as being limited to these terms. The terms are used only to distinguish one component and another component from each other.

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module and be implemented by the processor (not shown) except for a “module” or a “˜er/or” that needs to be implemented by a specific hardware.

Hereinafter, embodiments of the present disclosure are described in detail with reference to the accompanying drawings so that those skilled in the art to which the present disclosure pertains may easily practice the present disclosure. However, the present disclosure may be modified in various different forms, and is not limited to the embodiments provided herein. In addition, in the drawings, portions unrelated to the description are omitted to clearly describe the present disclosure, and similar portions are denoted by similar reference numerals throughout the specification.

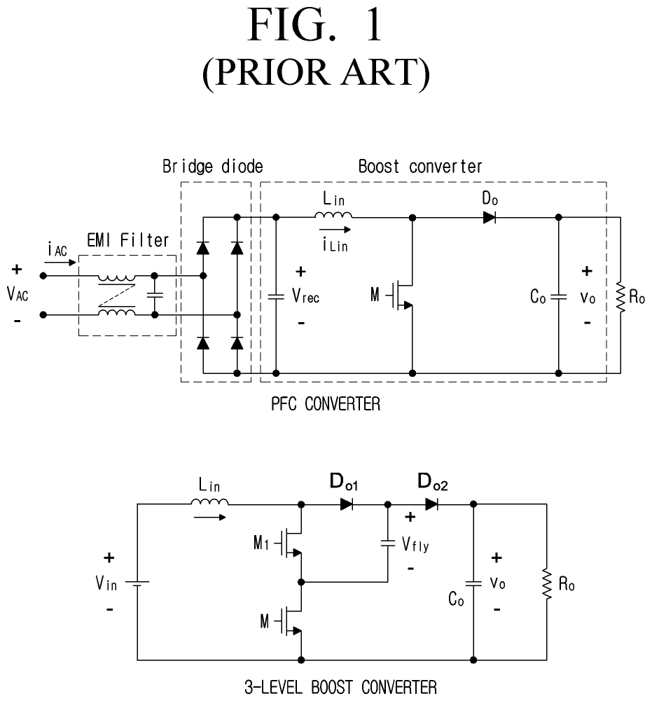

FIG. 1 is a diagram for describing a power factor correction (PFC) circuit and a 3-level PFC circuit according to prior art.

An electronic apparatus having a single-phase alternate current (AC) power input of 75 W or more may include a power factor correction (PFC) converter to comply with power factor and high-frequency related regulations. The PFC circuit according to the prior art may use a boost converter topology as shown in an upper part of FIG. 1.

A switch M included in the PFC circuit shown in the upper part of FIG. 1 may have a large voltage stress and a large current ripple of an inductor (Lᵢₙ), thus requiring the inductor (Lᵢₙ) having a relatively large magnitude.

To address such a disadvantage of the boost converter topology requiring a relatively large inductor (Lᵢₙ), a 3-level PFC circuit using a 3-level boost converter topology is proposed, as shown in a lower part of FIG. 1.

For example, an operation of the 3-level PFC circuit may be classified into a buck mode, in which an input voltage is greater than half of an output voltage, and a boost mode, in which the input voltage is less than half of the output voltage.

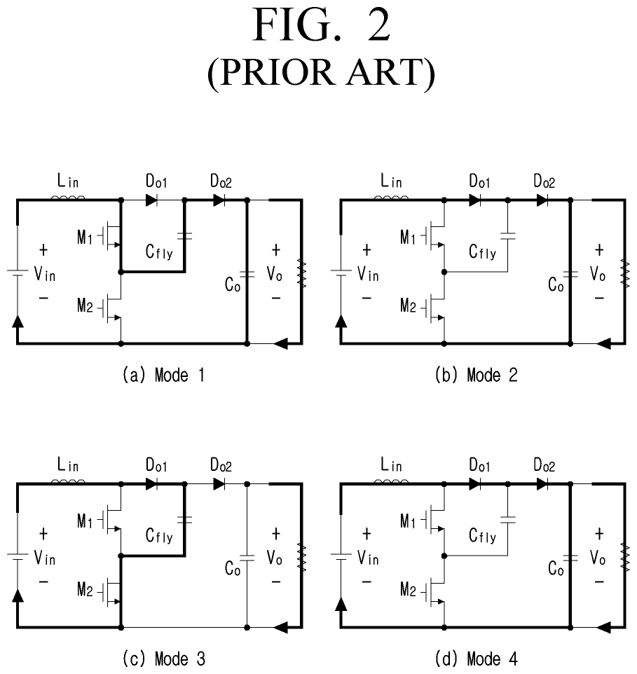

A detailed description thereof is provided with reference to FIGS. 2 to 5.

FIG. 2 is a diagram for describing the 3-level PFC circuit operated in the buck mode.

In the conventional boost converter, a voltage applied to the inductor (Lᵢₙ) during a turning-on period of the switch M (e.g., a boosting phase) may be an input voltage (Vᵢₙ), whereas in the 3-level boost converter, the voltage applied to the inductor (Lᵢₙ) may be Vᵢₙ+V_{fly}−Vₒ or Vᵢₙ−V_{fly} if a first switch (M₁) or a second switch (M₂) is turned on. Therefore, a current ripple of the inductor (Lᵢₙ) may be reduced if a magnitude of a flying voltage (V_{fly}) is half of an output voltage (Vₒ) (e.g., Vₒ/2).

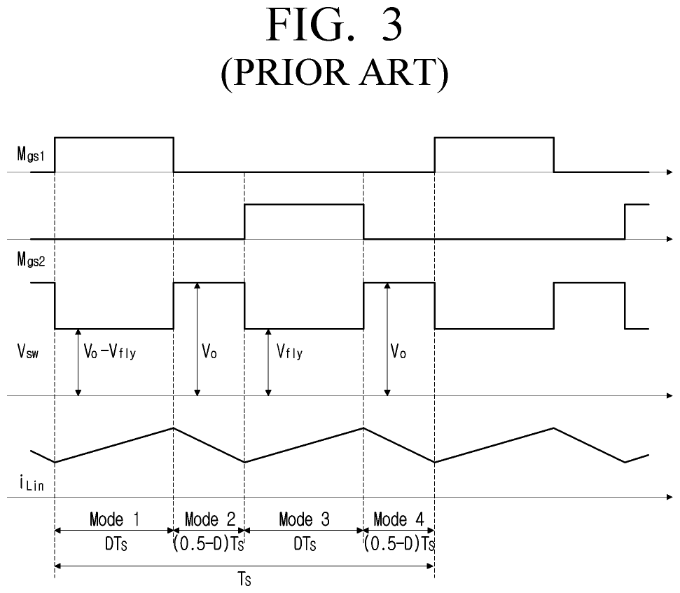

FIG. 3 is a diagram for describing a main waveform of the 3-level PFC circuit operated in the buck mode.

In particular, referring to FIG. 3, the first switch (M₁) or the second switch (M₂) may be alternately turned on while having a phase difference of 180 degrees within a single switching cycle, an operation frequency of the inductor (Lᵢₙ) may thus be twice a switching frequency, and the current ripple may therefore be further reduced, as shown in Equation 1 below. Meanwhile, Equation 2 represents the current ripple of the inductor (Lᵢₙ) included in the PFC circuit based on a conventional boost converter topology.

$$Δ {L}_{in} = ( ( {V}_{in} - {V}_{0} / 2 ) / ( 2 {f}_{sw} {L}_{in} ) ) * D \qquad [ Equation 1 ]$$

$$Δ {L}_{in} = ( ( {V}_{in} ) / ( {f}_{sw} {L}_{in} ) ) * D \qquad [ Equation 2 ]$$

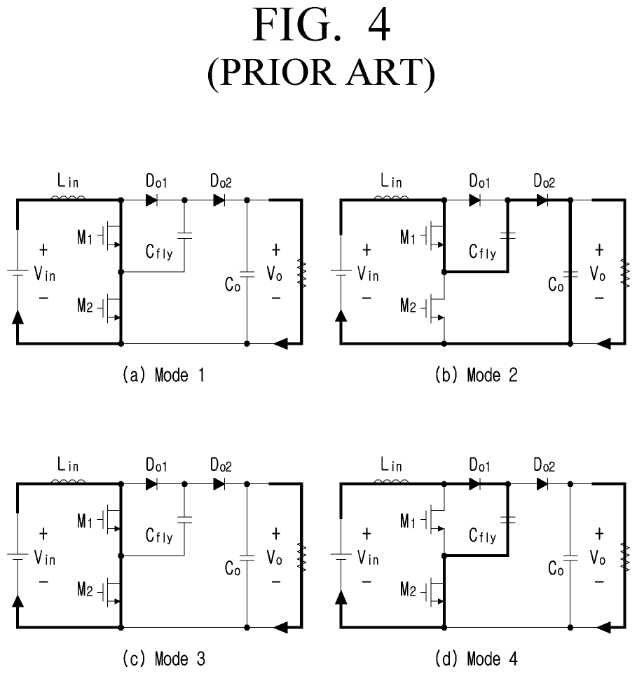

FIG. 4 is a diagram for describing a 3-level PFC circuit operated in a boost mode. In the conventional boost converter, a voltage applied to the inductor (Lᵢₙ) may be −(Vₒ−Vᵢₙ) during a turning-off period of the switch M (e.g., a powering phase), whereas in the 3-level boost converter, as shown in FIG. 4, a voltage applied to the inductor (Lᵢₙ) may be −(Vₒ−V_{fly}−Vᵢₙ) if either the first switch (M₁) or the second switch (M₂) is turned off. Accordingly, the current ripple of the inductor (Lᵢₙ) may be reduced if a magnitude of the flying voltage (V_{fly}) is half of the output voltage (Vₒ) (e.g., Vₒ/2).

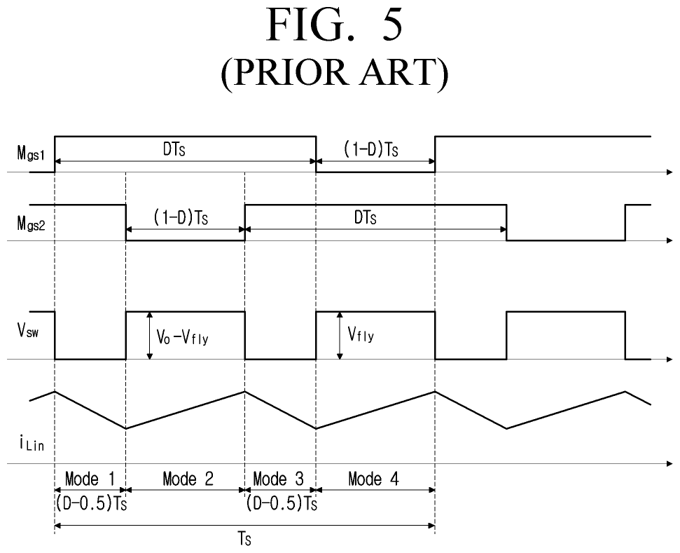

FIG. 5 is a diagram for describing a main waveform of the 3-level PFC circuit operated in a boost mode.

In particular, referring to FIG. 5, the first switch (M₁) or the second switch (M₂) may be alternately turned off while having the phase difference of 180 degrees within the single switching cycle. The operation frequency of the inductor (Lᵢₙ) may thus be twice the switching frequency, and the current ripple may therefore be further reduced, as shown in Equation 3 below. Meanwhile, Equation 4 represents the current ripple of the inductor (Lᵢₙ) included in the PFC circuit based on the conventional boost converter topology.

$$Δ {L}_{in} = ( ( {V}_{0} / 2 - {V}_{in} ) / ( 2 {f}_{sw} {L}_{in} ) ) * ( 1 D ) \qquad [ Equation 3 ]$$

$$Δ {L}_{in} = ( ( {V}_{0} - {V}_{in} ) / ( {f}_{sw} {L}_{in} ) ) * ( 1 D ) \qquad [ Equation 4 ]$$

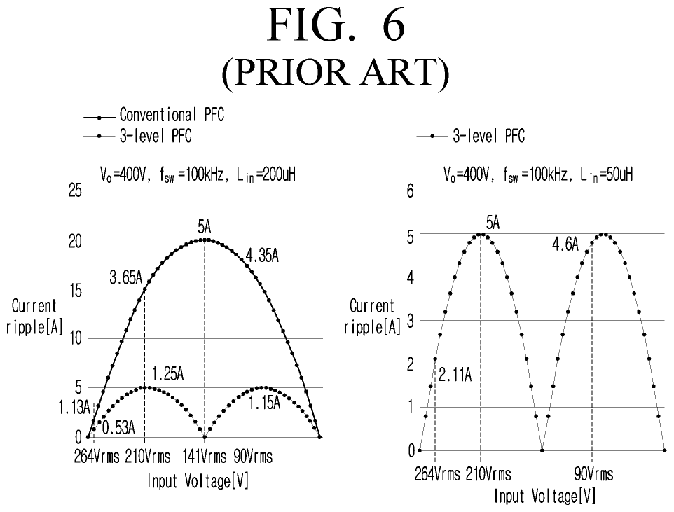

FIG. 6 is a graph for comparing a magnitude of the inductor included in the PFC circuit with a magnitude of the inductor included in the 3-level PFC circuit.

FIG. 6 is a graph showing the current ripple based on the input voltage (Vᵢₙ) of each of the conventional boost converter and the 3-level boost converter under the same operating condition, if a magnitude of the inductor (Lᵢₙ) is 200 uH.

Referring to a left graph in FIG. 6, it may be seen that the maximum current ripple of the 3-level boost converter is ¼ times that of the conventional boost converter.

Referring to a right graph in FIG. 6, if the magnitude of the inductor (Lᵢₙ) included in the 3-level boost converter is 50 uH (e.g., one-fourth of that of the inductor (Lᵢₙ) included in the conventional boost converter, which is 200 uH), the maximum current ripple of the inductor (Lᵢₙ) in the 3-level boost converter and the maximum current ripple of the inductor (Lᵢₙ) in the conventional boost converter may be similar to each other.

As described above, in a conventional PFC circuit using the 3-level boost converter topology, the voltage stress on each of the first switch (M₁) and the second switch (M₂) may be relatively lower (for example, by a half level) than the voltage stress on the switch M included in a PFC circuit using the boost converter topology.

In addition, the current ripple of the PFC circuit using the conventional 3-level boost converter topology may be relatively lower (for example, by a one-fourth level) than the current ripple of the PFC circuit using the boost converter topology, thereby implementing the PFC circuit including the inductor (Lᵢₙ) having a small magnitude.

However, in the PFC circuit using the 3-level boost converter topology, if the flying voltage (V_{fly}) of the flying capacitor is not controlled to half of the output voltage (Vₒ), the voltage stress on each of the first switch (M₁) and the second switch (M₂) may increase, and the current ripple of the inductor (Lᵢₙ) may also excessively increase.

The 3-level PFC circuit according to various example embodiments of the present disclosure may efficiently and continuously control the flying voltage (V_{fly}) of the flying capacitor to half of the output voltage (Vₒ), thereby suppressing the increase in the voltage stress on each of the first switch (M₁) and the second switch (M₂), and preventing or reducing the excessive increase in the current ripple of the inductor (Lᵢₙ).

Hereinafter, a control circuit for controlling the 3-level PFC circuit according to the various example embodiments of the present disclosure is described. Before describing the control circuit according to various example embodiments, each of i) a conventional control circuit for controlling the PFC circuit using the boost converter topology and ii) a conventional control circuit for controlling the PFC circuit using the 3-level boost converter topology is first described.

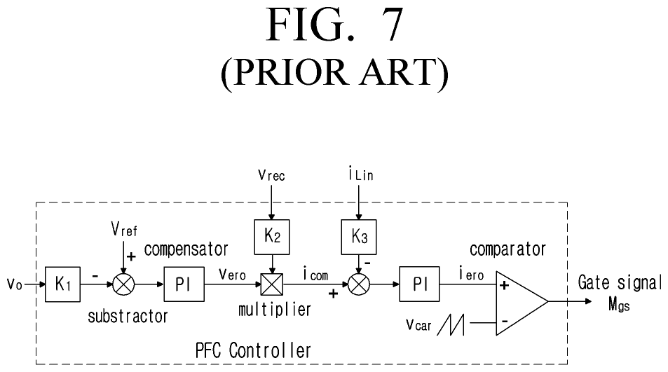

FIG. 7 is a diagram for describing the control circuit for controlling the PFC circuit included in an electronic apparatus according to prior art.

Referring to FIG. 7, the PFC circuit may control an AC input current lac to make its phase identical to that of an AC input voltage Vac and minimize a harmonic component, and is required to maintain the output voltage (Vₒ) constant.

To this end, the control circuit according to the prior art may first use a proportional integral (PI) compensator to reduce a difference between the output voltage (Vₒ) converted by a sensing gain K₁ and a reference output voltage (V_{ref}) (or a voltage command), and obtain an inductor current command (i_{com}) based on a product of K₂V_{rec} and a voltage control signal Vₑᵣₒ output by the proportional integral compensator.

Next, the control circuit may use the proportional integral compensator to enable a current i_{Lin} flowing through the inductor, e.g., K₃i_{Lin} converted using the sensing gain K₃, to correspond to the inductor current command (i_{com}), and may obtain a current control signal iₑᵣₒ output by the proportional integral compensator.

Next, the control circuit may obtain a PWM signal M_{gs} on the basis of the current control signal iₑᵣₒ and a return signal V_{car}, and may control the turning on and off of the switch M on the basis of M_{gs}.

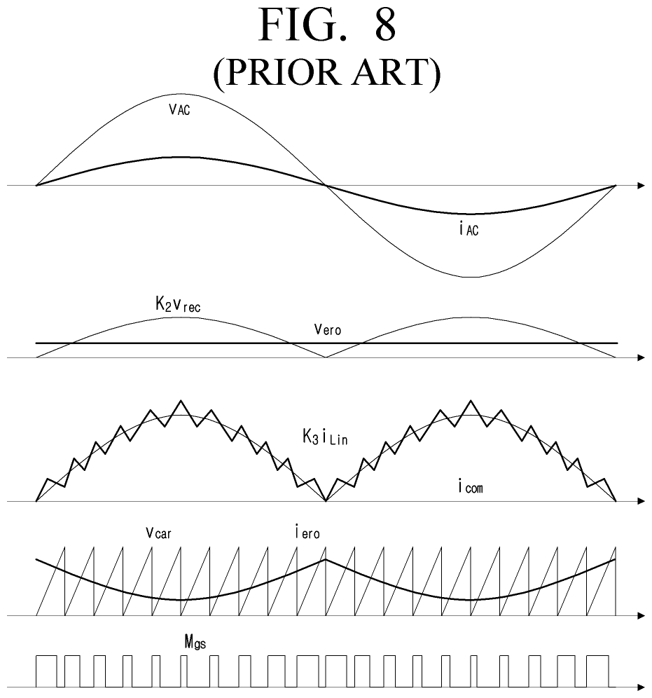

FIG. 8 is a diagram for describing a main waveform of the PFC circuit included in the electronic apparatus according to prior art.

Referring to FIG. 8, the return signal V_{car} may be a sawtooth wave return signal, and the PWM signal M_{gs} may be the on-off control signal for the switch M.

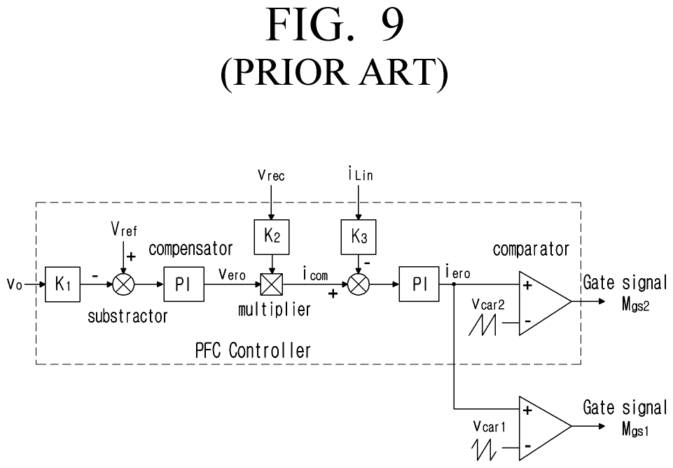

FIG. 9 is a diagram for describing a control circuit for controlling the 3-level PFC circuit included in the electronic apparatus according to prior art.

Referring to FIG. 9, the control circuit for controlling the 3-level PFC circuit may be operated similarly to the control circuit for controlling the PFC circuit using the boost converter topology. However, the control circuit for controlling the 3-level PFC circuit differs in that the control circuit for controlling the 3-level PFC circuit may control the turning on and off of each of the first switch (M₁) and the second switch (M₂).

If an on-off signal having the identical duty ratio D and the phase difference of 180 degrees is applied to each of the first switch (M₁) and the second switch (M₂) in a normal state, the control circuit may maintain the flying voltage (V_{fly}) of the flying capacitor at half of the output voltage (Vₒ), thereby minimizing the current ripple of the inductor (Lᵢₙ).

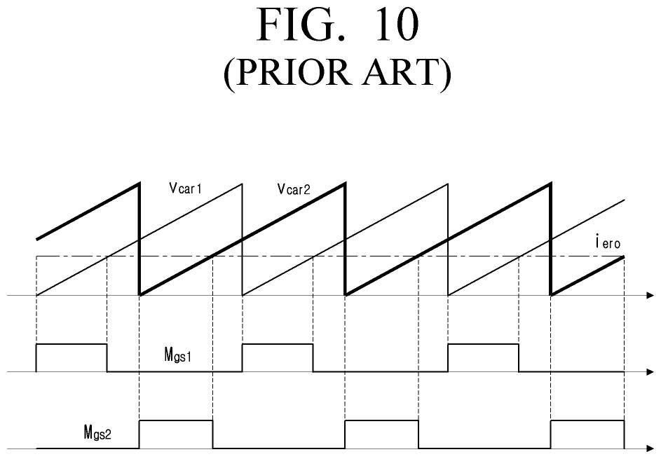

FIG. 10 is a graph for describing a pulse width modulation (PWM) signal from the control circuit for controlling the 3-level PFC circuit according to prior art.

The control circuit according to the prior art may obtain the current control signal iₑᵣₒ as described with reference to FIG. 7, and may output an on-off control signal M_{gs1} for the first switch (M₁) and an on-off control signal M_{gs2} for the second switch (M₂) by comparing a first return signal V_{car1} with a second return signal V_{car2} having the phase difference of 180 degrees.

However, to enable the control circuit according to the prior art to output the on-off control signal M_{gs1} for the first switch (M₁) and the on-off control signal M_{gs2} for the second switch (M₂), respectively, as shown in FIG. 10, characteristics of a plurality of switches included in the PFC circuit, for example, the first switch (M₁) and the second switch (M₂), are required to be identical to each other, characteristics of a plurality of diodes are required to be identical to each other, and no deviation is required to occur in an on or off operation based on the on-off control signal. However, it is impossible for characteristics of the devices to be identical to each other, or to avoid a deviation occurring between application of the signal and the operation. Accordingly, it is impossible to maintain the flying voltage (V_{fly}) at half of the output voltage (Vₒ), and normal control of the 3-level PFC circuit may become impossible.

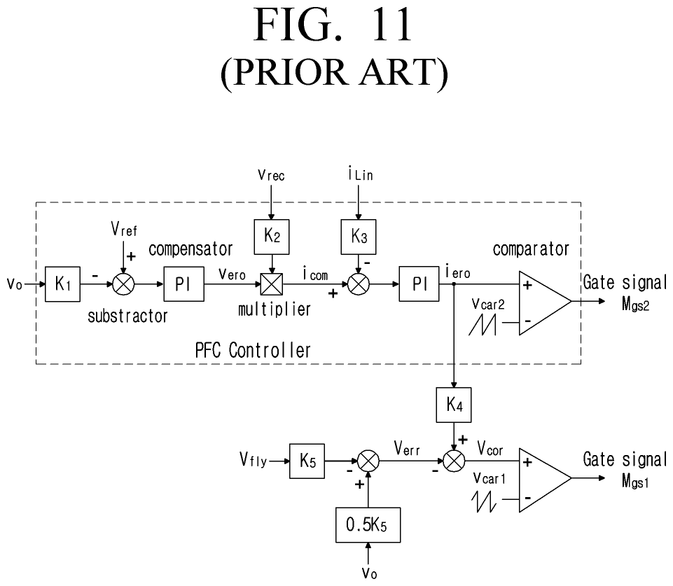

FIG. 11 is a diagram for describing the control circuit for controlling the 3-level PFC circuit to maintain the magnitude of the flying voltage at half of a magnitude of the output voltage according to prior art.

For example, the control circuit for controlling the 3-level PFC circuit may obtain the on-off control signal M_{gs1} for the first switch (M₁) by compensating for the current control signal iₑᵣₒ on the basis of the flying voltage (V_{fly}) and the output voltage (Vₒ) to maintain the magnitude of the flying voltage at half of the magnitude of the output voltage.

Referring to FIG. 11, the control circuit may include a first control circuit and a second control circuit.

As described with reference to FIG. 9, the first control circuit may use the proportional integral (PI) compensator to reduce the difference between the output voltage (Vₒ) converted using the sensing gain K₁ and the reference output voltage (V_{ref}) (or the voltage command), and obtain the inductor current command (i_{com}) based on the product of K₂V_{rec} and the voltage control signal Vₑᵣₒ output by the proportional integral compensator.

Next, the first control circuit may use the proportional integral compensator to enable the current i_{Lin} flowing through the inductor, e.g., K₃i_{Lin} converted using the sensing gain K₃, to correspond to the inductor current command (i_{com}), and may obtain the current control signal iₑᵣₒ output by the proportional integral compensator.

Next, the first control circuit may obtain the on-off control signal M_{gs2} for the second switch (M₂) on the basis of the current control signal iₑᵣₒ and the second return signal V_{car2}.

In addition, the second control circuit may obtain V_{cor} by compensating for a current control signal K₄iₑᵣₒ converted using a sensing gain K₄, based on a difference between a flying voltage K₅V_{fly} converted using a sensing gain K₅ and 0.5K₄V₀, which is half of the output voltage (Vₒ) converted using the sensing gain K₅. Next, the second control circuit may obtain the on-off control signal M_{gs1} for the first switch (M₁) on the basis of V_{cor} and the first return signal V_{car1}.

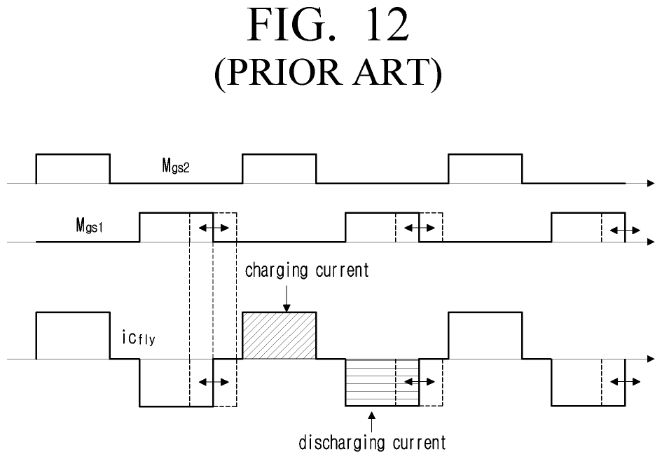

FIG. 12 is a graph for describing a waveform of the on-off control signal for the first switch and a waveform of the on-off control signal for the second switch according to prior art.

Referring to FIG. 12, the second control circuit may increase the flying voltage (V_{fly}) by reducing a pulse width of the on-off control signal M_{gs1} for the first switch (M₁) to reduce a discharging current flowing through a flying capacitor (C_{fly}) if the magnitude of the flying voltage (V_{fly}) is less than half of the output voltage (Vₒ), and may reduce the flying voltage (V_{fly}) by increasing the pulse width of the on-off control signal M_{gs1} for the first switch (M₁) to increase the discharging current flowing through the flying capacitor (C_{fly}) if the magnitude of the flying voltage (V_{fly}) is greater than half of the output voltage (Vₒ).

However, as shown in FIG. 12, in the prior art, if an error occurs between the magnitude of the flying voltage (V_{fly}) and Vₒ/2, which is half of the magnitude of the output voltage (Vₒ), the pulse width may be increased or reduced only at a falling edge time point of the on-off control signal M_{gs1} for the first switch (M₁). Accordingly, it is impossible to maintain the phase difference of 180 degrees between the on-off control signal M_{gs1} for the first switch (M₁) and the on-off control signal M_{gs2} for the second switch (M₂) in a transient state, which results in an imbalance in the current flowing through the inductor.

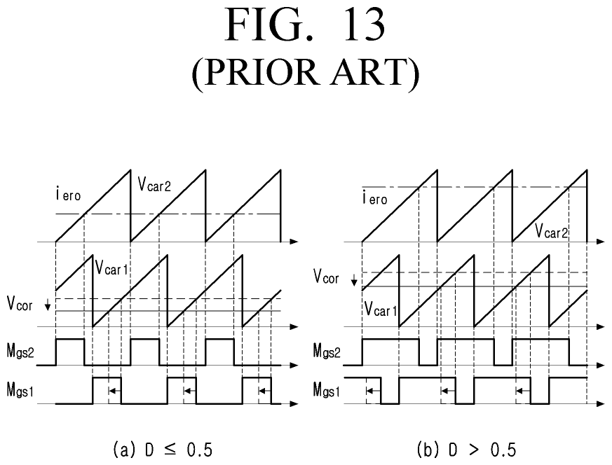

FIG. 13 is a graph for describing the PWM signal from the control circuit for controlling the 3-level PFC circuit according to prior art.

In an example, the control circuit according to the prior art may use the sawtooth wave return signal. Accordingly, the duty ratios D of the on-off control signal M_{gs1} for the first switch (M₁) and the on-off control signal M_{gs2} for the second switch (M₂) may be identical to each other only if the current control signal iₑᵣₒ and V_{cor} are identical to each other, thereby maintaining the phase difference of 180 degrees. In another example, if the current control signal iₑᵣₒ and V_{cor} are not identical to each other, the duty ratios D of the on-off control signal M_{gs1} for the first switch (M₁) and the on-off control signal M_{gs2} for the second switch (M₂) may be different from each other, thereby failing to maintain the phase difference of 180 degrees, and deteriorating dynamic characteristics in controlling the flying voltage (V_{fly}) of the flying capacitor (C_{fly}), which makes the transient state longer.

In addition, the second control circuit may obtain V_{cor} and the on-off control signal M_{gs1} for the first control circuit M₁ after the first control circuit outputs the current control signal iₑᵣₒ. Therefore, the dynamic characteristics in controlling the flying voltage (V_{fly}) may depend on performance of the first control circuit (or PFC control circuit) that outputs the current control signal iₑᵣₒ.

In addition, the second control circuit may obtain V_{cor} by compensating for the current control signal iₑᵣₒ only based on proportional constants K₄ and K₅, and the first return signal V_{car1} and the second return signal V_{car2} may maintain constant magnitudes and a constant offset regardless of the operating condition of the PFC circuit. The magnitude of the flying voltage (V_{fly}) may correspond to Vₒ/2, which is half of the magnitude of the output voltage (Vₒ), only if each of the first switch (M₁) and the second switch (M₂) is ideal. If the magnitude of the flying voltage (V_{fly}) does not correspond to Vₒ/2, which is half of the output voltage (Vₒ), that is, the error occurs, the current ripple may increase and the voltage stress on each of the first switch (M₁) and the second switch (M₂) may increase.

A control circuit according to an embodiment of the present disclosure may include a first control circuit and a second control circuit, and unlike the prior art, the first control circuit and the second control circuit may be operated independently of each other.

For example, referring to FIG. 11, the second control circuit included in the conventional control circuit may output the current control signal iₑᵣₒ from the first control circuit and then obtain V_{cor} and the on-off control signal M_{gs1} for the first switch (M₁). Therefore, the second control circuit may have a limitation in securing the optimal performance for controlling the flying voltage (V_{fly}). However, according to the various embodiments of the present disclosure, performance of the second control circuit does not depend on performance of the first control circuit, and the first control circuit and the second control circuit may each be operated independently of each other.

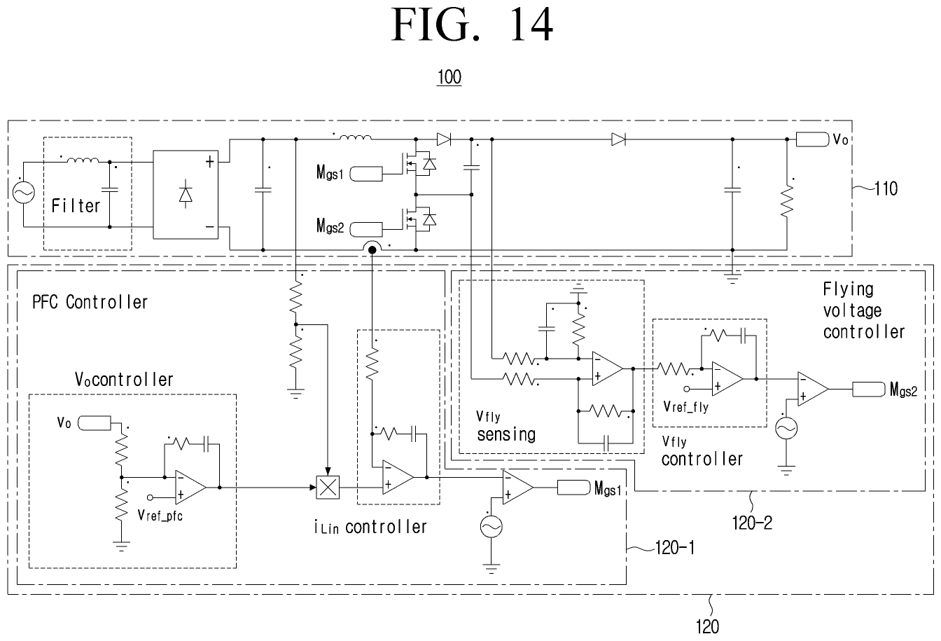

FIG. 14 is a diagram for describing the 3-level PFC circuit and the control circuit according to an example non-limiting embodiment of the present disclosure.

Referring to FIG. 14, the electronic apparatus 100 according to an embodiment of the present disclosure may include a power factor correction (PFC) circuit 110 and a control circuit 120, and the control circuit 120 may include a first control circuit 120-1 and a second control circuit 120-2.

First, FIG. 14 shows the control circuit according to an embodiment of the present disclosure that is implemented as an analog circuit. The first control circuit 120-1 and the second control circuit 120-2 may each be implemented as independent and separate circuits, and, for example, may be implemented as a general-purpose PFC integrated circuit (IC) and a general-purpose direct current to direct current (DC/DC) controller.

Here, the electronic apparatus 100 may perform wired/wireless communication with an external device such as a personal computer (PC) or a set-top box to receive an video signal, may also receive the video signal by using a tuner or the like that is internally included in the electronic apparatus 100, or may obtain the image signal by using image data stored in a storage included in the electronic apparatus 100. Next, the electronic apparatus 100 may provide the video signal to the external device (e.g., a display device).

Meanwhile, a power line of the electronic apparatus 100 may be connected directly or indirectly to a power outlet for providing commercial power (e.g., 90 to 264 V), and the electronic apparatus 100 may transmit commercial power to the external device. The electronic apparatus 100 according to an embodiment may be implemented as any of various types of apparatus for supplying power to the external device.

The external device may be implemented as the display device and display video data. Here, the display device may be implemented as a television (TV), is not limited thereto, and may use any device having a display function, such as a video wall, a large format display (LFD), a digital signage, a digital information display (DID), or a projector display without limitation. In addition, the display device may be implemented as any of various types of displays, such as a liquid crystal display (LCD), an organic light emitting diode (OLED) display, a liquid crystal on silicon (LCoS), a digital light processing (DLP), a quantum dot (QD) display panel, a quantum dot light-emitting diode (QLED) display, a micro light-emitting diode (μLED), or a mini LED display. In addition, the display device may display the video signal received from the electronic apparatus 100 and may be driven using power supplied from the electronic apparatus 100.

The example described above assumes that the electronic apparatus 100 and the external device are implemented separately from each other. However, this configuration is merely an example, and the present disclosure is not limited thereto. The electronic apparatus 100 and the external device may be implemented as a single device. For example, the electronic apparatus 100 may be implemented as a component (e.g., a power supply) of the external device.

The electronic apparatus 100 (e.g., the power supply) according to an embodiment of the present disclosure may be implemented as a switched mode power supply (SMPS) and may include a power factor correction circuit, e.g., the PFC circuit 110, to meet an increase in total power consumption and various regulations due to/caused by an enlargement of the electronic apparatus 100.

According to an embodiment of the present disclosure, the electronic apparatus 100 may be a hardware that converts alternating current (AC) power into direct current (DC) power and stably supplies power to an internal load of the electronic apparatus 100 (or the external device). The electronic apparatus 100 may include a plurality of switches and may control turning on and off of each of the plurality of switches to provide stable power to the load.

Meanwhile, the electronic apparatus 100 according to an embodiment of the present disclosure may include a diode bridge (or a bridge rectifier), an electromagnetic interference (EMI) filter unit, or the like. For example, the diode bridge may be a bridge circuit that connects four diodes to one another and may be a component that rectifies an AC input/AC input and changes the rectified AC input into a DC output. The EMI filter may remove electrical noise from commercial power.

The electronic apparatus 100 according to an embodiment may include the PFC circuit 110. Here, the PFC circuit 110 may be implemented as any of various types of converters such as a buck converter, a boost converter, or a buck-boost converter.

Meanwhile, according to an embodiment of the present disclosure, hereinafter, the PFC circuit 110 is assumed as a PFC circuit using the 3-level boost converter topology. According to an embodiment, the PFC circuit 110 may be operated in a buck mode if an input voltage (Vᵢₙ) is greater than half of an output voltage (Vₒ), and may be operated in a boost mode if the input voltage (Vᵢₙ) is less than half of the output voltage (Vₒ).

Meanwhile, the control circuit 120 may be implemented as a digital signal control circuit (digital signal processor (DSP), a micro control circuit (microprocessor), or a Timing controller (T-CON), which processes a digital video signal. However, the control circuit 120 is not limited thereto, and may include at least one of a central processing unit (CPU), a micro controller unit (MCU), a micro processing unit (MPU), a controller, an application control circuit (or an application processor (AP)), a communication control circuit (or a communication processor (CP)), an ARM control circuit, or may be defined by a relevant term. In addition, the control circuit 120 may be implemented as a system-on-chip (SoC) or a large scale integration (LSI) that has a processing algorithm embedded therein, or may be implemented in the form of a field programmable gate array (FPGA). Each “processor” herein may comprise processing circuitry.

For example, the control circuit 120 may include the first control circuit 120-1 and the second control circuit 120-2. Here, the first control circuit 120-1 may be referred to as a PFC circuit controller, and the second control circuit 120-2 may be referred to as controller of a flying voltage (V_{fly}) of the flying capacitor (C_{fly}). However, for convenience of description, the controllers are hereinafter collectively referred to as the first control circuit 120-1 and the second control circuit 120-2, respectively.

According to an embodiment, the first control circuit 120-1 may output the on-off control signal M_{gs1} (e.g., a gate signal) for the first switch (M₁), and the second control circuit may output the on-off control signal M_{gs2} (e.g., a gate signal) for the second switch (M₂). In addition, the first control circuit 120-1 and the second control circuit 120-2 may be operated independently of each other, and a specific embodiment thereof is described below.

Here, the signal may include a signal supplied to a gate to cause current to flow through the switch. Meanwhile, in the present disclosure, a “configuration for turning on the switch” indicates changing the switch from a non-conductive state to a conductive state. In particular, the “configuration for turning on the switch” indicates supplying a signal to the gate to cause current to flow through the switch. On the other hand, a “configuration for turning off the switch” indicates changing the switch from a conductive state to a non-conductive state.

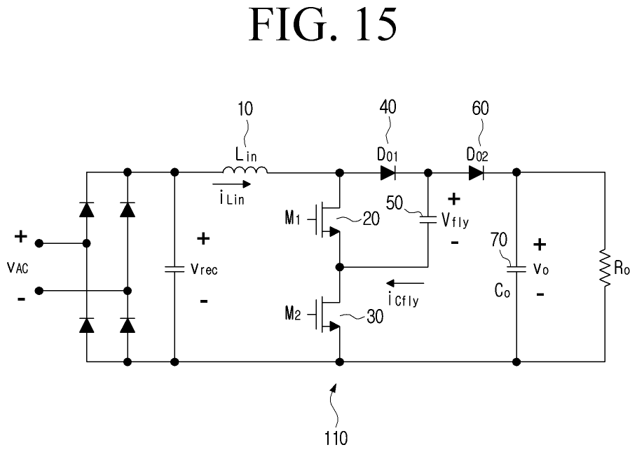

FIG. 15 is a circuit diagram for describing the 3-level PFC circuit according to an embodiment of the present disclosure.

Referring to FIG. 15, the PFC circuit 110 may include an inductor (Lᵢₙ) 10 connected directly or indirectly to one end of the input voltage unit.

In addition, the PFC circuit 110 may include a switch unit including a first switch (M₁) 20 connected in series with the inductor (Lᵢₙ) 10 and a second switch (M₂) 30 connected in series with the first switch (M₁) 20.

In addition, the PFC circuit 110 may include a flying capacitor circuit connected in parallel with the first switch (M₁) 20, and including a first diode (Dₒ₁) 40 and a flying capacitor (C_{fly}) 50 connected in series with each other.

In addition, the PFC circuit 110 may include an output unit connected in parallel with the flying capacitor (C_{fly}) 50 and the second switch (M₂) 30, and including a second diode (Dₒ₂) 60 and an output capacitor (Cₒ) 70 connected in series with each other.

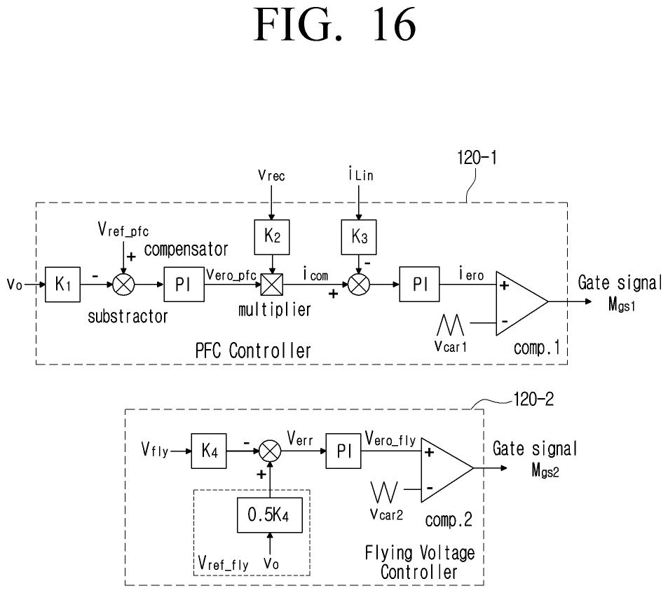

FIG. 16 is a diagram for describing each of the first control circuit and the second control circuit according to an embodiment of the present disclosure.

First, the first control circuit 120-1 may obtain the on-off control signal M_{gs1} for the first switch (M₁) on the basis of the output voltage (Vₒ) of the output capacitor (Cₒ) 70, and may transmit the obtained on-off control signal M_{gs1} to the first switch (M₁).

In addition, the second control circuit 120-2 may obtain the on-off control signal M_{gs2} for the second switch (M₂) on the basis of the flying voltage (V_{fly}) of the flying capacitor (C_{fly}) 50, and may transmit the obtained on-off control signal M_{gs2} to the second switch (M₂).

The first control circuit 120-1 according to an embodiment may use a proportional integral (PI) compensator to reduce a difference between the output voltage (Vₒ) converted by a sensing gain K₁ and a reference output voltage (V_{ref_pfc}) (or a voltage command) (or, to make an error zero), and obtain an inductor current command (i_{com}) based on a product of K₂V_{rec} and a first voltage control signal Vₑᵣₒ output by the proportional integral compensator.

Next, the first control circuit 120-1 may use the proportional integral compensator to convert a current i_{Lin} flowing through the inductor, e.g., K₃i_{Lin} obtained using the sensing gain K₃, to correspond to the inductor current command (i_{com}), and may obtain a current control signal iₑᵣₒ output by the proportional integral compensator.

Next, the first control circuit 120-1 may obtain the on-off control signal M_{gs1} for the first switch (M₁) on the basis of a current control signal iₑᵣₒ and a first return signal V_{car1}.

Here, the first return signal V_{car1} may be a triangle wave return signal.

According to an embodiment, the second control circuit 120-2 may obtain a second voltage control signal V_{ero_fly} independently of the first control circuit 120-1 by using the proportional integral compensator to reduce a difference between K₄V_{fly}, which is the flying voltage (V_{fly}) converted using a sensing gain K₄, and 0.5K₄V₀, which is a reference flying voltage converted using the sensing gain K₄ (or the control command (V_{ref_pfc})) (or make the error zero/or, make the error zero). Here, the control command (V_{ref_pfc}) may correspond to half of the output voltage (Vₒ). According to an embodiment, the control command (V_{ref_pfc}) may be a value obtained by converting the output voltage (Vₒ) using 0.5 and the sensing gain K₄, or may be a DC voltage reference corresponding to the magnitude of 0.5K₄V₀.

Next, the second control circuit 120-2 may obtain the on-off control signal M_{gs2} for the second switch (M₂) on the basis of a second voltage control signal V_{ero_fly} and a second return signal V_{car2}.

Here, the second return signal V_{car2} may be a triangle wave return signal. According to an embodiment, the first return signal V_{car1} and the second return signal V_{car2} may be the same triangle wave return signal or may be different triangle wave return signals having a phase difference of 180 degrees.

According to an embodiment of the present disclosure, the output voltage (Vₒ) may be controlled based on the on-off control signal M_{gs1} for the first switch (M₁) output by the first control circuit 120-1, and the flying voltage (V_{fly}) may be controlled based on the on-off control signal M_{gs2} for the second switch (M₂) output by the second control circuit 120-2. Therefore, the first control circuit 120-1 and the second control circuit 120-2 may be operated independently of each other, and the output voltage (Vₒ) and the flying voltage (V_{fly}) may be controlled independently of each other.

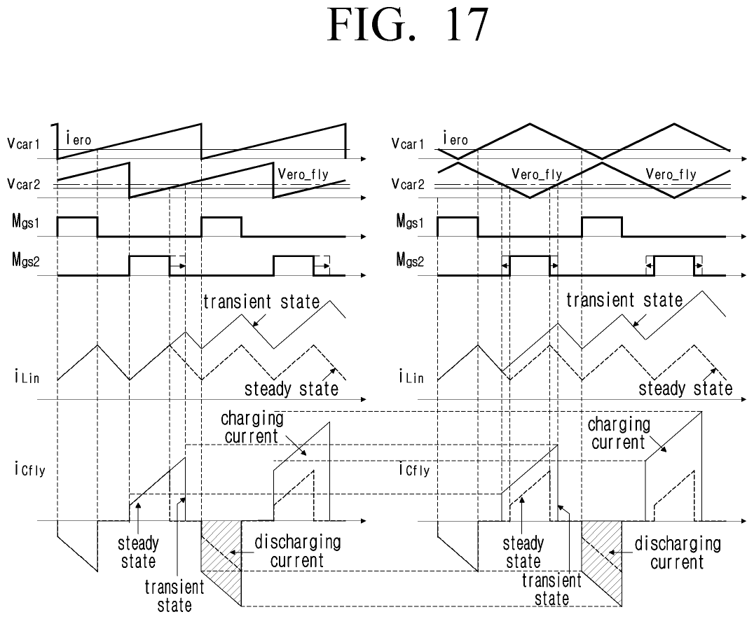

FIG. 17 is a diagram for describing a charging or discharging current flowing through the flying capacitor based on the triangle wave return signal according to an embodiment of the present disclosure.

In the second control circuit 120-2 according to an embodiment of the present disclosure, an error (Vₑᵣᵣ) may have a positive (+) or negative (−) value, rather than a zero value, in a case where the error (Vₑᵣᵣ) occurs between K₄V_{fly}, which is the flying voltage (V_{fly}) converted using the sensing gain K₄, and 0.5K₄V₀, which is the reference flying voltage converted using the sensing gain K₄.

For example, if the error (Vₑᵣᵣ) is input to the proportional integral compensator, the second voltage control signal V_{ero_fly} output by the proportional integral compensator may vary continuously (or in real time), and a comparator Comp. 2 may compare the second voltage control signal V_{ero_fly} with the second return signal V_{car2}, and convert the same into the on-off control signal M_{gs2} for the second switch (M₂).

For example, the proportional integral compensator may continuously vary the second voltage control signal V_{ero_fly} until the error (Vₑᵣᵣ) becomes neither positive (+) nor negative (−) but zero. Finally, if the error (Vₑᵣᵣ) becomes zero and a magnitude of the flying voltage (V_{fly}) corresponds to half of a magnitude of the output voltage (Vₒ), the electronic apparatus may enter a steady state. That is, in the steady state, the error (Vₑᵣᵣ) may be neither positive (+) nor negative (−) but zero.

In addition, according to an embodiment of the present disclosure, even if there is a difference in magnitude between the first return signal V_{car1} and the second return signal V_{car2}, an offset difference therebetween, or a difference in device characteristics between the first switch (M₁) and the second switch (M₂), the magnitude of the flying voltage (V_{fly}) may correspond to half of the magnitude of the output voltage (Vₒ) in the steady state by the proportional integral compensator.

Referring to FIG. 17, each of the first return signal V_{car1} and the second return signal V_{car2} may be the triangle wave return signal. Accordingly, the phase difference between the on-off control signal M_{gs1} for the first switch (M₁) and the on-off control signal M_{gs2} for the second switch (M₂) may be maintained as 180 degrees regardless of variation in the current control signal iₑᵣₒ and the second voltage control signal V_{ero_fly}.

Meanwhile, FIG. 17 is a graph showing a difference in the charging or discharging current flowing through the flying capacitor (C_{fly}), based on a sawtooth wave return signal (see a left part of FIG. 17) or the triangle wave return signal (see a right part of FIG. 17), during an operation for controlling the second switch (M₂) of the second control circuit 120-2, in a case where the input voltage (Vᵢₙ) is greater than half (0.5 Vₒ) of the output voltage (Vₒ) (e.g., Vᵢₙ>0.5 Vₒ or a duty ratio D<0.5), and the flying voltage (V_{fly}) is less than half of the output voltage (Vₒ) (e.g., V_{fly}<0.5 Vₒ).

Referring to FIG. 17, the flying voltage (V_{fly}) may increase because the flying voltage (V_{fly}) is less than half of the output voltage (Vₒ) (V_{fly}<0.5 Vₒ), and the current i_{Lin} flowing through the inductor (Lᵢₙ) may also increase if the duty ratio D increases in each of the sawtooth wave return signal (see the left part) and the triangle wave return signal (see the right part), while having the same magnitude.

However, for the current icy flowing through the flying capacitor (C_{fly}), there is no difference in a magnitude of the discharging current between the sawtooth wave return signal and the triangle wave return signal. However, a magnitude of the charging current may be greater in case of the triangle wave return signal than in case of the sawtooth wave return signal. That is, at the same duty ratio D, an increase in the flying voltage (V_{fly}) may be greater in case of the triangle wave return signal than in case of the sawtooth wave return signal.

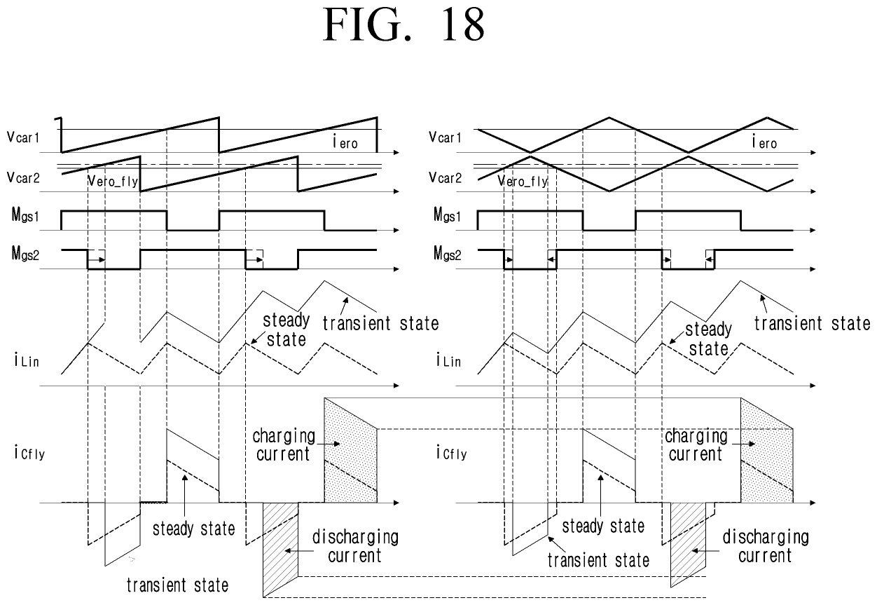

FIG. 18 is a diagram for describing the charging or discharging current flowing through the flying capacitor based on the triangle wave return signal according to an embodiment of the present disclosure.

FIG. 18 is a graph showing a difference in the charging or discharging current of the flying capacitor (C_{fly}), based on the sawtooth wave return signal (see a left part of FIG. 18) or the triangle wave return signal (see a right part of FIG. 18), during the operation for controlling the second switch (M₂) of the second control circuit 120-2, which is performed if the input voltage (Vᵢₙ) is less than half (0.5 V₀) of the output voltage (e.g., Vᵢₙ<0.5 V₀ or the duty ratio D>0.5), and the flying voltage (V_{fly}) is less than half of the output voltage (Vₒ) (e.g., V_{fly}<0.5 V₀).

Referring to FIG. 18, the flying voltage (V_{fly}) may increase because the flying voltage (V_{fly}) is less than half of the output voltage (Vₒ) (e.g., V_{fly}<0.5 Vₒ), and the current i_{Lin} flowing through the inductor (Lᵢₙ) may also increase if the duty ratio D increases in each of the sawtooth wave return signal (see the left part) and the triangle wave return signal (see the right part), while having the same magnitude.

However, for the current icy flowing through the flying capacitor (C_{fly}), there is no difference in the magnitude of the charging current between the sawtooth wave return signal and the triangle wave return signal. However, the magnitude of the discharging current may be greater in case of the sawtooth wave return signal than in case of the triangle wave return signal. That is, at the same duty ratio D, the increase in the flying voltage (V_{fly}) may be greater in case of the triangle wave return signal than in case of the sawtooth wave return signal.

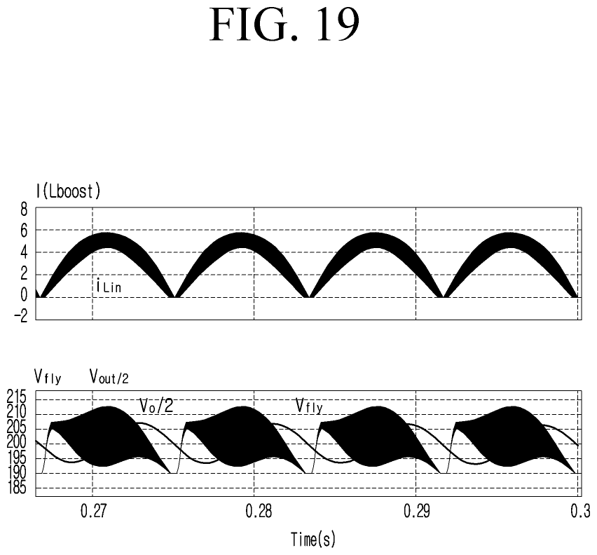

FIG. 19 is a graph for describing the output voltage and flying voltage of the 3-level PFC circuit if there is a difference between the return signals according to an embodiment of the present disclosure.

FIG. 19 is a graph showing a simulated waveform of the current i_{Lin} flowing through the inductor (Lᵢₙ) and the flying voltage (V_{fly}) at Vᵢₙ=110 Vᵣₘₛ, in a case where there is a 1 V offset between the first return signal V_{car1} and the second return signal V_{car2} according to an embodiment of the present disclosure (e.g., a peak-to-peak voltage of the return signal is 10 V).

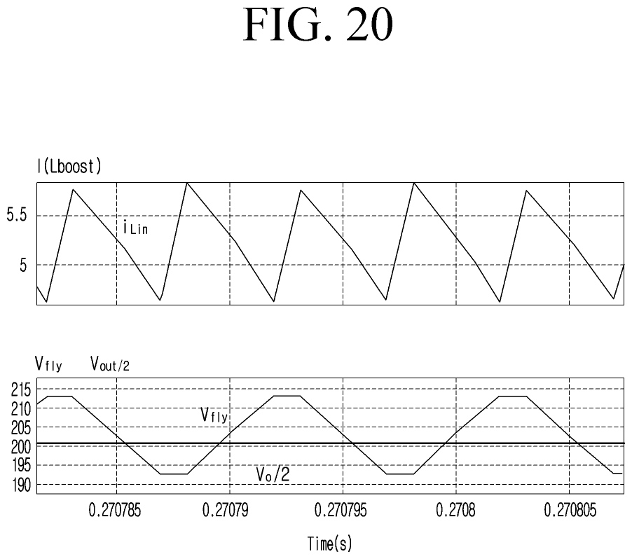

FIG. 20 is a diagram for describing a change in the current flowing through the inductor included in the 3-level PFC circuit if there is a difference between the return signals according to an embodiment of the present disclosure.

As shown in FIGS. 19 and 20, even if there is an offset between the first return signal V_{car1} and the second return signal V_{car2}, the flying voltage (V_{fly}) may be maintained at half of the output voltage (Vₒ) without a steady-state error.

FIG. 20 shows an enlarged waveform in a case where the current flowing through the inductor (Lᵢₙ) is the largest, at Vᵢₙ=110 Vᵣₘₛ, Vₒ=400 V, and Pₒ=400 W. As shown in FIG. 20, the current flowing through the inductor (Lᵢₙ) may maintain equilibrium.

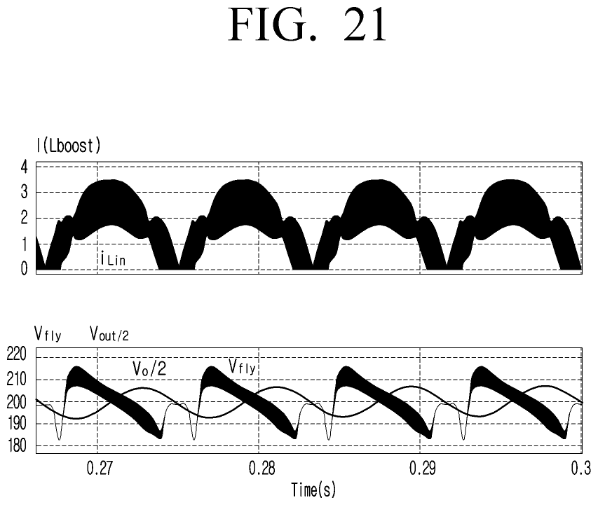

FIG. 21 is a graph for describing the output voltage and flying voltage of the 3-level PFC circuit if there is a difference between the return signals according to an embodiment of the present disclosure.

FIG. 21 is a graph showing a simulated waveform of the current i_{Lin} flowing through the inductor (Lᵢₙ) and the flying voltage (V_{fly}) at Vᵢₙ=220 Vᵣₘₛ, in a case where there is a 1 V offset between the first return signal V_{car1} and the second return signal V_{car2} according to an embodiment of the present disclosure (e.g., the peak-to-peak voltage of the return signal is 10 V).

As shown in FIG. 21, even if there is an offset between the first return signal V_{car1} and the second return signal V_{car2}, the flying voltage (V_{fly}) may be maintained at half of the output voltage (Vₒ) without the steady-state error. Meanwhile, the simulation experiments shown in FIGS. 19 to 21 were performed under the assumption that Lᵢₙ=150 uF, C_{fly}=1 uF, and f_{sw}=100 kHz.

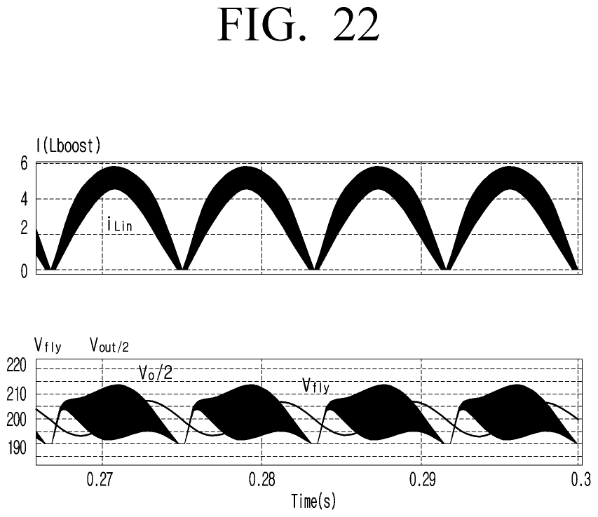

FIG. 22 is a graph for describing the output voltage and flying voltage of the 3-level PFC circuit if there is a difference between the gate signals according to an embodiment of the present disclosure.

FIG. 22 is a graph showing a simulated waveform of the current i_{Lin} flowing through the inductor (Lᵢₙ) and the flying voltage (V_{fly}) at Vᵢₙ=110 Vᵣₘₛ, in a case where there is a 200 nanosecond (ns) difference between the on-off control signal M_{gs1} for the first switch (M₁) and the on-off control signal M_{gs2} for the second switch (M₂), and accordingly, the duty ratios D are not identical.

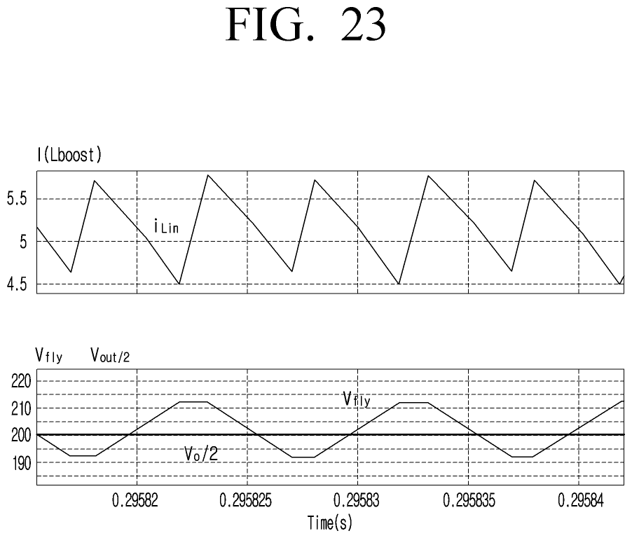

FIG. 23 is a diagram for describing a change in the current flowing through the inductor included the 3-level PFC circuit if there is a difference between the gate signals according to an embodiment of the present disclosure.

As shown in FIGS. 22 and 23, even if the duty ratios D of the on-off control signal M_{gs1} for the first switch (M₁) and the on-off control signal M_{gs2} for the second switch (M₂) are not identical, the flying voltage (V_{fly}) may be maintained at half of the output voltage (Vₒ) without the steady-state error.

FIG. 23 shows an enlarged waveform in a case where the current flowing through the inductor (Lᵢₙ) is the largest, at Vᵢₙ=110 Vᵣₘₛ, Vₒ=400 V, and Pₒ=400 W. As shown in FIG. 23, the current flowing through the inductor (Lᵢₙ) may maintain equilibrium.

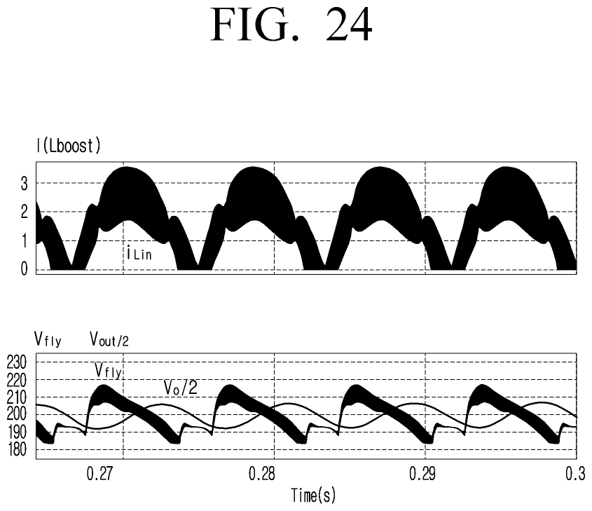

FIG. 24 is a graph for describing the output voltage and flying voltage of the 3-level PFC circuit if there is a difference between the gate signals according to an embodiment of the present disclosure.

FIG. 24 is a graph showing a simulated waveform of the current i_{Lin} flowing through the inductor (Lᵢₙ) and the flying voltage (V_{fly}) at Vᵢₙ=2200 Vᵣₘₛ, in a case where the duty ratios D are not identical due to the 200 ns difference between the on-off control signal M_{gs1} for the first switch (M₁) and the on-off control signal M_{gs2} for the second switch (M₂).

As shown in FIG. 24, even if the duty ratios D of the on-off control signal M_{gs1} for the first switch (M₁) and the on-off control signal M_{gs2} for the second switch (M₂) are not identical, the flying voltage (V_{fly}) may be maintained at half of the output voltage (Vₒ) without the steady-state error. Meanwhile, simulation experiments shown in FIGS. 22 to 24 were performed under the assumption that Lᵢₙ=150 uF, C_{fly}=1 uF, and f_{sw}=100 kHz.

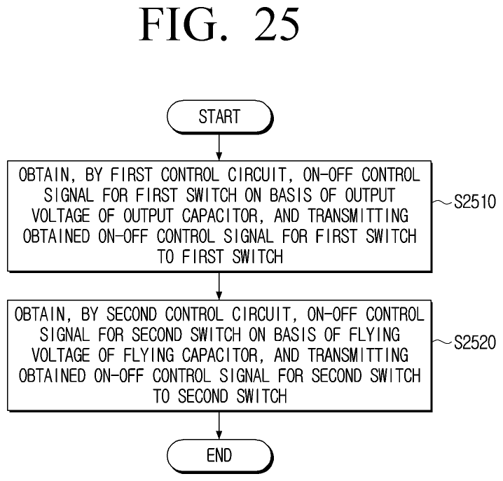

FIG. 25 is a flowchart for describing a control method of an electronic apparatus according to an embodiment of the present disclosure.

According to an embodiment of the present disclosure, provided is the control method of an electronic apparatus which includes the power factor correction (PFC) circuit and the control circuit for controlling the operation of the PFC circuit, the PFC circuit including the inductor connected to one end of the input voltage unit, the switch unit including the first switch connected in series with the inductor and the second switch connected in series with the first switch, the flying capacitor unit connected in parallel with the first switch, and including the first diode and the flying capacitor connected in series with each other, and the output unit connected in parallel with the flying capacitor and the second switch, and including the second diode and the output capacitor connected in series with each other, the method first includes obtaining, by the first control circuit included in the control circuit, the on-off control signal for the first switch on the basis of the output voltage of the output capacitor, and transmitting the obtained on-off control signal for the first switch to the first switch (S2510). “Connected” as used herein covers both direct and indirect connections.

Next, the method includes obtaining the on-off control signal for the second switch on the basis of the flying voltage of the flying capacitor, and transmitting the obtained on-off control signal for the second switch to the second switch (S2520).

According to an embodiment, the transmitting of the obtained on-off control signal for the first switch to the first switch (S2510) may include obtaining the first voltage control signal for reducing the difference between the output voltage and the reference output voltage, obtaining the current control signal on the basis of the first voltage control signal and the current flowing through the inductor, and obtaining the on-off control signal for the first switch on the basis of the current control signal and the first return signal.

The first return signal according to an embodiment may be the triangle wave return signal.

According to an embodiment, the transmitting of the obtained on-off control signal for the second switch to the second switch (S2520) may include obtaining the second voltage control signal for reducing the difference between the flying voltage and the reference flying voltage, and obtaining the on-off control signal for the second switch on the basis of the second voltage control signal and the second return signal.

According to an embodiment, the reference flying voltage may correspond to half of the output voltage.

According to an embodiment, the transmitting of the obtained on-off control signal for the first switch to the first switch (S2510) may include obtaining the first voltage control signal for reducing the difference between the output voltage and the reference output voltage, obtaining a reference current on the basis of the first voltage control signal and the input voltage of the input voltage unit, obtaining the current control signal for enabling the current flowing through the inductor to correspond to the reference current, and obtaining the on-off control signal for the first switch on the basis of the current control signal and the first return signal, and according to an embodiment, the transmitting of the obtained on-off control signal for the second switch to the second switch (S2520) may include obtaining the second voltage control signal for reducing the difference between the flying voltage and the reference flying voltage, and obtaining the on-off control signal for the second switch on the basis of the second voltage control signal and the second return signal. “Based on” and “on the basis of” as used herein cover based at least on.

According to an embodiment, the second return signal may be the triangle wave return signal, and the first return signal and the second return signal may the same as each other or different from each other.

According to an embodiment, the transmitting of the obtained on-off control signal for the second switch to the second switch (S2520) may include controlling turning on and off of the second switch to adjust the magnitude of the flying voltage to half of the magnitude of the output voltage.

According to an embodiment, the PFC circuit is the 3-level boost converter circuit, and the first control circuit and the second control circuit may be operated independently of each other.

However, the various embodiments of the present disclosure may be applied not only to the electronic apparatus, but also to all types of the electronic apparatus having the SMPS.

Meanwhile, the various embodiments of the present disclosure described above may be implemented in a recording medium readable by a computer or similar device using software, hardware, or a combination thereof. In some cases, the embodiments described in the specification may be implemented by the processor itself. In software implementation, the embodiments such as the procedures and functions described in the specification may be implemented by separate software modules. Each of the software modules may perform one or more functions and operations described in the specification.

Meanwhile, a non-transitory computer-readable medium may store computer instructions for performing processing operations of the electronic apparatus 100 according to the various embodiments of the present disclosure described above. The computer instructions stored in the non-transitory computer-readable medium may allow a specific device to perform the processing operations of the electronic apparatus according to the various embodiments described above if executed by a processor of the specific device.

The non-transitory computer-readable medium indicates a medium that semi-permanently stores data therein and is readable by the machine instead of a medium that stores data therein temporarily, such as a register, a cache, or a memory. A specific example of the non-transitory computer-readable medium may include a compact disk (CD), a digital versatile disk (DVD), a hard disk, a blu-ray disk, a universal serial bus (USB), a memory card, a read only memory (ROM), or the like.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic apparatus comprising:
a power factor correction (PFC) circuit; and
a control circuit configured to control an operation of the PFC circuit,
wherein the PFC circuit includes:
an inductor connected to a first end of an input voltage unit comprising circuitry,
a switch unit including a first switch connected in series with an inductor and a second switch connected in series with the first switch,
a flying capacitor unit connected in parallel with the first switch, and including a first diode and a flying capacitor connected in series with each other, and
an output unit connected in parallel with the flying capacitor and the second switch, and including a second diode and an output capacitor connected in series with each other, and
wherein the control circuit includes:
a first control circuit configured to obtain an on-off control signal for the first switch based on an output voltage of the output capacitor, and transmit the obtained on-off control signal for the first switch to the first switch, and
a second control circuit configured to obtain an on-off control signal for the second switch based on a flying voltage of the flying capacitor, and transmit the obtained on-off control signal for the second switch to the second switch.

2. The apparatus as claimed in claim 1, wherein the first control circuit is configured to:
obtain a first voltage control signal for reducing a difference between the output voltage and a reference output voltage,
obtain a current control signal based on the first voltage control signal and a current flowing through the inductor, and
obtain the on-off control signal for the first switch based on the current control signal and a first return signal.

3. The apparatus as claimed in claim 2, wherein the first return signal is a triangle wave return signal.

4. The apparatus as claimed in claim 1, wherein the second control circuit is configured to:
obtain a second voltage control signal for reducing a difference between the flying voltage and a reference flying voltage, and
obtain the on-off control signal for the second switch based on the second voltage control signal and a second return signal.

5. The apparatus as claimed in claim 4, wherein the reference flying voltage corresponds to half of the output voltage.

6. The apparatus as claimed in claim 1, wherein the first control circuit is configured to:
obtain a first voltage control signal for reducing a difference between the output voltage and a reference output voltage,
obtain a reference current based on the first voltage control signal and an input voltage of the input voltage unit,
obtain a current control signal for enabling a current flowing through the inductor to correspond to the reference current, and
obtain the on-off control signal for the first switch based on the current control signal and a first return signal, and
the second control circuit is configured to:
obtain a second voltage control signal for reducing a difference between the flying voltage and a reference flying voltage, and
obtain the on-off control signal for the second switch based on the second voltage control signal and a second return signal.

7. The apparatus as claimed in claim 6, wherein the second return signal is a triangle wave return signal, and
the first return signal and the second return signal are the same as each other or different from each other.

8. The apparatus as claimed in claim 1, wherein the second control circuit is configured to control turning on and off of the second switch to adjust a magnitude of the flying voltage to half of a magnitude of the output voltage.

9. The apparatus as claimed in claim 1, wherein the PFC circuit comprises a 3-level boost converter circuit, and
the first control circuit and the second control circuit are configured to be operated independently of each other.

10. A control method of an electronic apparatus, which includes a power factor correction (PFC) circuit, and a control circuit for controlling an operation of the PFC circuit, the PFC circuit including an inductor connected to an end of an input voltage unit, a switch unit including a first switch connected in series with an inductor and a second switch connected in series with the first switch, a flying capacitor unit connected in parallel with the first switch, and including a first diode and a flying capacitor connected in series with each other, and an output unit connected in parallel with the flying capacitor and the second switch, and including a second diode and an output capacitor connected in series with each other, the method comprising:
obtaining, at least by a first control circuit included in the control circuit, an on-off control signal for the first switch based on an output voltage of the output capacitor, and transmitting the obtained on-off control signal for the first switch to the first switch; and
obtaining, at least by a second control circuit included in the control circuit, an on-off control signal for the second switch based on a flying voltage of the flying capacitor, and transmitting the obtained on-off control signal for the second switch to the second switch.

11. The method as claimed in claim 10, wherein the transmitting of the obtained on-off control signal for the first switch to the first switch includes:
obtaining a first voltage control signal for reducing a difference between the output voltage and a reference output voltage,
obtaining a current control signal based on the first voltage control signal and a current flowing through an inductor, and
obtaining the on-off control signal for the first switch based on the current control signal and a first return signal.

12. The method as claimed in claim 11, wherein the first return signal is a triangle wave return signal.

13. The method as claimed in claim 10, wherein the transmitting of the obtained on-off control signal for the second switch to the second switch includes:
obtaining a second voltage control signal for reducing a difference between the flying voltage and a reference flying voltage, and
obtaining the on-off control signal for the second switch based on the second voltage control signal and a second return signal.

14. The method as claimed in claim 13, wherein the reference flying voltage corresponds to half of the output voltage.

15. The method as claimed in claim 10, wherein the transmitting of the obtained on-off control signal for the first switch to the first switch includes:
obtaining a first voltage control signal for reducing a difference between the output voltage and a reference output voltage,
obtaining a reference current based on the first voltage control signal and an input voltage of the input voltage unit,
obtaining a current control signal for enabling current flowing through the inductor to correspond to the reference current, and
obtaining the on-off control signal for the first switch based on the current control signal and a first return signal, and
the transmitting of the obtained on-off control signal for the second switch to the second switch includes
obtaining a second voltage control signal for reducing a difference between the flying voltage and a reference flying voltage, and
obtaining the on-off control signal for the second switch based on the second voltage control signal and a second return signal.

16. The method as claimed in claim 15, wherein the second return signal is a triangle wave return signal, and
the first return signal and the second return signal are the same as each other or different from each other.

17. The method as claimed in claim 10, wherein the second control circuit is configured to control turning on and off of the second switch to adjust a magnitude of the flying voltage to half of a magnitude of the output voltage.

18. The method as claimed in claim 10, wherein the PFC circuit comprises a 3-level boost converter circuit, and
the first control circuit and the second control circuit are configured to be operated independently of each other.
